(19) United States
(12) Patent Application Publication
(10) Pub. No.: US 2026/0091718 A1
(43) Pub. Date: Apr. 2, 2026

(54) VEHICLE HAVING A CONVERTIBLE FRONT HOOD

(71) Applicant: Ford Global Technologies, LLC, Dearborn, MI (US)

(72) Inventors: Michael Georg Figura, Dormagen (DE); Torsten Kluge, Overath (DE); Klaus Achterberg, Hennef (DE)

(21) Appl. No.: 19/338,105

(22) Filed: Sep. 24, 2025

(30) Foreign Application Priority Data
Oct. 1, 2024 (DE) 102024128339.4

(51) Int. Cl. B60N 3/00; B62D 25/12

(52) U.S. Cl. CPC B60N 3/001; B62D 25/12

(57) ABSTRACT

An assembly includes a first hood portion supportable by a vehicle structure and a second hood portion that is pivotable relative to the first hood portion about an axis between a closed position and a usage position. The second hood portion having an outside surface and an inside surface opposite the outside surface. A pivoting and holding device attaches the second hood portion to the vehicle structure such that the second hood portion is pivoted about the pivot axis from the closed position into the usage position that comprises a table position in which the inside surface has been pivoted outward and protrudes beyond the first hood portion.

### CROSS-REFERENCE TO RELATED APPLICATION

This application is a U.S. non-provisional application claiming the benefit of German Application No. 102024128339.4, filed on October 1, 2024, which is incorporated herein by reference in its entirety.

### TECHNICAL FIELD

This disclosure relates to a vehicle comprising a front hood that closes a compartment, and which has an outside surface and an opposite inside surface.

### BACKGROUND

Vehicles have a front hood in order to cover and engine compartment for reasons of styling and aerodynamics. This front hood is generally fastened near a rear edge to a body via hinges which allow the hood to be tilted within a small angular range for opening and closing.

Battery-operated vehicles (BEVs, also hybrid vehicles) are being developed in order to either reduce, or completely, eliminate dependence on internal combustion engines. With electrified vehicles having appeared on the automobile market, many existing components in the vehicle engine compartment may become unnecessary. The excess space provided by the removal of these components makes a front storage compartment possible, which is also called a front trunk or "frunk". The term "frunk" is composed of the terms "front" and "trunk". Front trunks are cargo spaces that are located in the front of the vehicle, and which are typically accessible by opening the front hood of the vehicle. Of course, there are still vehicles with an internal combustion engine on the market, in the case of which the internal combustion engine is typically arranged in the front compartment, i.e. in the engine compartment. The engine compartment is accessible via the front hood as usual.

The vehicles mentioned at the outset are known, for example in the form of mobile workshops or motorhomes. Tradespersons and motorhome owners often desire a small table or a workbench which can be easily installed near the vehicle, e.g. a van or motorhome. These tables are generally a separate component which must be stowed in the luggage/cargo space of the motor vehicle during travel and must be properly fastened.

US 11142129B2 relates to a vehicle in the form of a pickup truck which, as an electrified vehicle, has the aforementioned frunk in the front region. The frunk is accessible when the front hood is opened. A panel is arranged in the frunk, which panel can be removed and can be arranged in a usage position and can be fastened at the front. In the usage position, the panel can act as a table or as a work surface.

US 4455948A relates to an automotive table for installation inside a vehicle in compact form attached to the vehicle floor, and extendable to a position outside the vehicle for use as a work platform or display of merchandise or the like. The table has on the underside two lazy tongs that are attached at their lower ends to the vehicle floor, typically the floor of the rear trunk. From its normal position inside the vehicle, the table is extended by pulling out the table top while the articulated struts move into their fully extended position. In the non-use position, the table is stored within the rear trunk and takes up much space there. During the extending, the table is lifted above the rear trunk wall.

A vehicle workbench assembly for the outside of a truck cargo area according to US 11310312B2 comprises an integrated workbench which is pivotably connected to the outside of the truck cargo area so that the integrated workbench can be moved between a locked position in a sidewall cavity of the outside of the truck cargo area and an operating position extending perpendicular thereto. The integrated workbench has a wheel gap for accommodating the truck wheel or the wheelhouse in the locked position. A wheel gap panel is provided in order to fill the cavity of the wheel gap in the operating position.

Utility model CN 211001037U provides a vehicle-mounted workbench having an upward folding function. The vehicle-mounted workbench comprises a panel, a bracket, a housing, and a rotary mechanism. The housing is fastened to the holder and the panel is rotatably connected to the holder by the rotary mechanism. When the housing is closed by the panel folded upward, a cavity, i.e. a closed box, is formed. Because the vehicle-mounted workbench has the upward folding function, it may increase the utilization of the useful space in a special vehicle.

### SUMMARY

This disclosure presents a vehicle with a table element that is simple and easily useable.

This is achieved according to the disclosure by a vehicle having the features of Claim 1.

A vehicle according to the disclosure includes a front compartment, which can be closed by a front hood, wherein the front hood has an outside and an opposite inside, wherein the outside is oriented toward the surroundings and the inside is oriented toward the front compartment when the front hood is in its closed usage position. According to the disclosure, at least a portion of the front hood is fastened to a vehicle structure by a pivoting and holding device in such a way that the pivotable portion of the front hood can be pivoted about a front pivot axis from the usage position of the pivotable portion of the front hood into a table position in which the inside has been pivoted outward, and in which the pivotable portion of the front hood protrudes, in particular forward, beyond a vehicle front.

Advantageous embodiments are disclosed in the dependent claims.

It should be pointed out that the features and measures mentioned individually in the description below can be combined with one another in any technically sensible way and present further embodiments of the disclosure. The description additionally characterizes and specifies the disclosure, in particular in connection with the figures.

The disclosure provides a flexibly usable vehicle which provides a table surface or a work surface in a simple way. For this purpose, the front hood or at least a portion thereof is simply assigned an additional function, specifically the function of a table or a work surface, besides the normal front-hood function which is anyway provided. This is achieved without the need to carry along additional material, to stow the material in such a way that space is taken up and to perform a complicated installation of the material. The front hood or at least its pivotable portion is simply pivoted from a closed usage position into the table position, in which the front hood or the pivoted-out portion thereof forms a full table for playing, eating, accessing the Internet or even working. Because the table or work surface thus formed protrudes, in particular forward, beyond the vehicle front, particularly easy accessibility is provided and, at the same time, wobbling is also not an issue, since the table or the work surface no longer has to be placed on a possibly uneven base surface, but rather is held directly on the vehicle in such a way that positional stability and tipping stability are achieved. And, because of the mounting on the vehicle, no table legs are required.

In the sense of the disclosure, "front pivot axis" means a virtual pivot axis arranged at the front. In an example embodiment, the front pivot axis is substantially perpendicular to the plane spanned by the longitudinal axis of the vehicle and the vertical axis of the vehicle. Of course, the angle can also deviate somewhat from the mentioned perpendicular angle, such a deviation lying in the tolerance range.

In an example embodiment, the pivoting and holding device is arranged in the front compartment.

In one embodiment, it is provided that, in the table position, the inside of at least the pivotable portion of the front hood is arranged horizontally, e.g., is arranged parallel to a base surface on which the vehicle stands. Because of the horizontal orientation, objects do not slide down. Of course, it is in accordance with the disclosure if the pivoting and holding device is adjustable so that, if the vehicle is parked on a slopping plane, the inside of at least the pivotable portion of the front hood can be oriented horizontally. This is discussed again below. For example, as a result of different loading states of the vehicle, in the table position, the inside will sometimes still have a slight inclination in the tolerance range of a few degrees relative to the base surface even after being oriented, but this can still be regarded as horizontal or parallel to the base surface according to the disclosure.

In another example embodiment, it is provided that the inside of at least the pivotable portion of the front hood is flat. Thus, a flat table surface is provided which, together with the horizontal orientation of at least the pivotable portion of the front hood, expediently has the result that objects do not fall over or slide down.

In one embodiment, it is provided that the front hood or at least the pivotable portion thereof has a reinforcing element so that the inside has sufficient stability when at least the pivotable portion of the front hood has been pivoted into the table position. In a favorable embodiment, the reinforcing element can be made of a rigid foam. Rigid foam provides the possibility of fastening coverings of the rigid foam according to the desired function. Furthermore, the reinforcing element provides the possibility of absorbing input loads during unfavorable traffic events.

As already stated, the inside can have a covering, which may be made of a solid material, such as wood, plastic or metal. In this way, a particularly resistant inside is provided which is sufficiently protected against events of unfavorable effect, such as scratches. In an additionally possible embodiment, the inside can also have a covering which allows grippers, clamping elements and/or tools and/or work devices such as a circular saw to be fastened. In such a case, the covering could consist of a perforated panel, i.e. a so-called peg board. In an expedient embodiment, the covering arranged on the inside, i.e. on the rigid foam block, is exchangeable. Thus, the type of covering to be arranged on the inside can be selected according to the wishes and requirements of the particular user of the vehicle. If, for example, the vehicle is a mobile workshop, the user may want a covering that allows their tools or even workpieces to be processed to be fastened to the inside. If, for example, the vehicle is a motorhome, the user may want a covering that is flat and has a surface which is as scratch-resistant as possible, so that at least the pivotable portion of the front hood can be used as a table that invites one to eat, to play or to set down terminal devices, for example for using the Internet.

In an example embodiment, the pivoting and holding device is provided, so that at least the pivotable portion of the front hood can be pivoted from the usage position into the table position and back. In an example embodiment, it is provided that the pivoting and holding device is fastened to at least the pivotable portion of the front hood by a hood strut and to a vehicle structure by a structure strut, wherein levers are provided which are at least rotatably connected to the hood strut and to the structure strut. This embodiment allows the pivoting and holding device to be produced as a prefabricated subassembly that can also be retrofitted. Of course, it is in accordance with the disclosure, if the structure strut and/or the hood strut is omitted, in which case the levers are connected, at the required position, to the front hood, at least to the pivotable portion of the front hood, and to the vehicle structure.

In this embodiment the hood strut and the structure strut are each firmly and immovably connected to the associated element, i.e. at least to the pivotable portion of the front hood and to the vehicle structure. In another embodiment, it is provided that the levers are each rotatably connected to the hood strut and to the structure strut.

By way of the rotatable levers, at least the pivotable portion of the front hood can thus be pivoted from the usage position into the table position and back. The levers can be designed and arranged such that, in the table position, the inside of at least the pivotable portion of the front hood is oriented horizontally. In an example embodiment, the levers can also be designed such that the inside can be leveled in the table position, so that the inside can be oriented horizontally even when the vehicle is parked on an inclined base surface. This is expedient in that a table or a work surface can be oriented horizontally in any case so that objects do not fall over or slide down. For this purpose, the end of at least one of the levers that is arranged on the hood strut can be translatable relative to the hood strut and can be able to be locked in a desired position. However, the pivoting and holding device not only has the pivoting function but also supports the pivoted-out portion. Thus, the pivoted-out portion is held on the vehicle in such a way that positional stability is achieved. The support function could be further facilitated by a (gas) spring between the levers or toward the struts or by an electric drive, in which case stops could also be provided for the end positions.

According to the disclosure, it is provided that the front hood or a pivotable portion thereof is permanently mounted on the vehicle structure, i.e. a vehicle body, a multi-link pivoting and holding device. The pivoting and holding device should make it possible to open the front hood or at least the pivotable portion thereof in a large angle in front of the vehicle so that the inside faces upward and is oriented horizontally/parallel to the ground, i.e. to the base surface, and at the same time forms a rest surface for eating, working and playing.

The inside is expediently reinforced by the reinforcing element, i.e. by a block made of rigid foam, and provides a flat surface which is covered with a solid material, e.g. wood, plastic or metal, and is located at such a distance from the outside of the front hood that external objects remain unaffected in the event of an unfavorable traffic event. The previously selected covering can be exchanged for differently structured coverings, for example for a peg panel, which provides the possibility of attaching a plurality of grippers and/or clamping devices and/or work devices.

The multi-link pivoting and holding device for opening and closing and the covering of the inside are designed such that loads such as a bowl or a circular saw can be sufficiently supported. Furthermore, in an example embodiment a design is provided in the case of which the height of the inside relative to the base surface on which the vehicle stands allows use as a table or workbench, e.g. 70-110 cm above the ground.

In another example embodiment, the pivoting and holding device has a pivot lever and a support element. In this embodiment, the aforementioned advantages can be achieved, wherein a structure strut and a hood strut and the aforementioned levers can be omitted. This simple and robust variant can be used in particular in the case of utility vehicles having a very short front overhang and a steep front hood. The pivot lever can be provided on both sides of the front hood or the pivotable portion thereof, and is in rotatably fastened at one of its ends to the vehicle structure to form the front pivot axis there, which in this embodiment is stationary. At its opposite end, the pivot lever is rigidly connected to the front hood or to at least the pivotable portion thereof. Thus, the front hood or at least the pivotable portion thereof can be pivoted from the usage position into the table position and back. In the table position, the front hood or at least the pivotable portion thereof can be supported by the support element. The support element can be expediently arranged on the front hood or on at least the pivotable portion thereof for this purpose, and in particular can be telescopingly extendable. In an example embodiment, the support element is arranged on the rear end of the front hood or the pivotable portion thereof and thus can be easily extended toward the base surface or at an inclination toward the vehicle structure, so that, in the table position, sufficient support is provided, with additional support by the pivot lever. Alternatively or additionally, it is possible to design a support element as an appropriately resistant hinge which is arranged on the front end of the front hood or the pivotable portion thereof.

### BRIEF DESCRIPTION OF THE DRAWINGS

Further advantageous embodiments of the disclosure are disclosed in the dependent claims and in the following description of the figures. The figures show:

FIG. 1 shows a vehicle in a perspective overall view;

FIG. 2 shows the vehicle from FIG. 1 with part of the front hood pivoted out;

FIG. 3 shows the vehicle from FIG. 2 in a side view with part of the front hood pivoted out;

FIG. 4 shows a pivoting and holding device as a detail; and

FIG. 5 shows a pivoting and holding device in a further embodiment in a side view.

### DETAILED DESCRIPTION

In the various figures, the same parts are always given the same reference signs, and therefore such parts are generally also described only once.

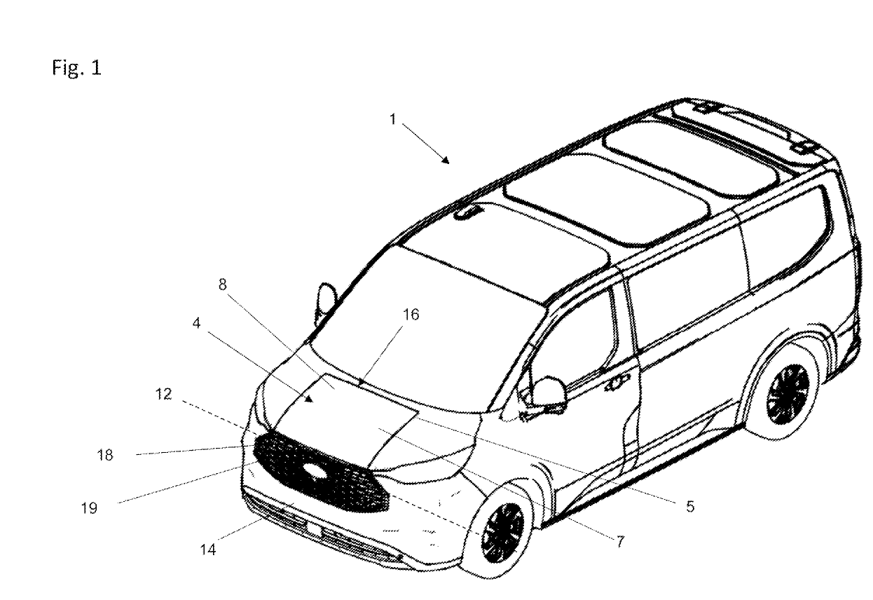

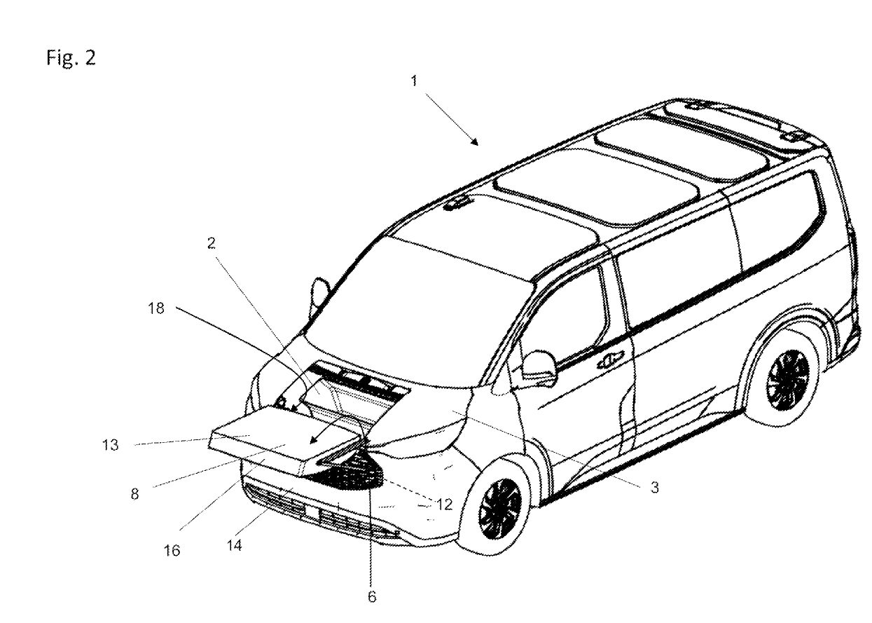

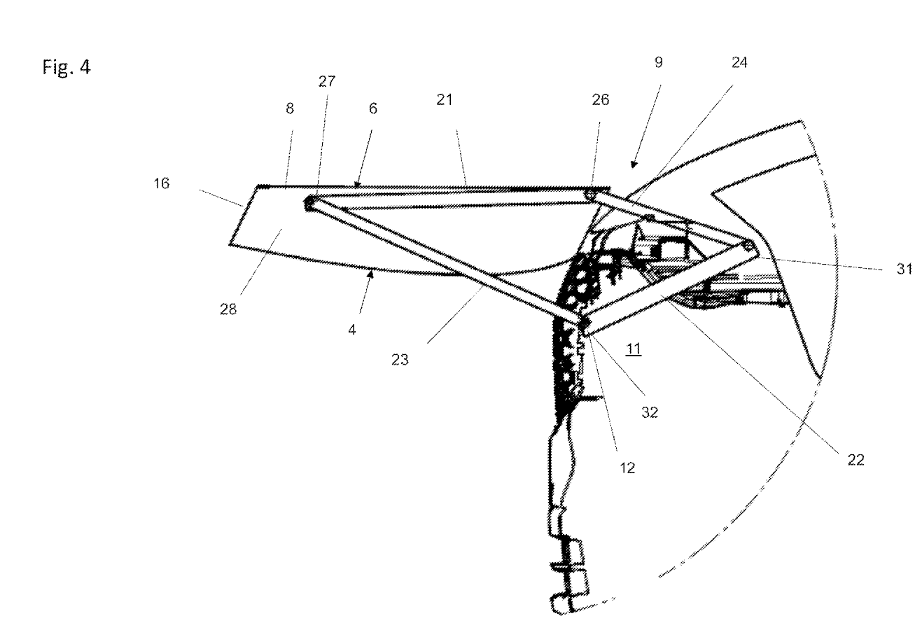

FIGS. 1 and 2 show a vehicle 1 in a perspective view. The vehicle 1 is, by way of example, in the form of a van or a motorhome. The vehicle 1 has a front compartment 2, which can be seen in FIG. 2 and which can be closed by a front hood 3. The front hood 3 has an outside 4 and an opposite inside 6. The outside 4 is oriented toward the surroundings of the vehicle 1 and the inside 6 is oriented toward the front compartment 2 when, as shown in FIG. 1, the front hood 3 is in its closed usage position 7. At least a portion 8 of the front hood 3 is fastened to a vehicle structure 11 by a pivoting and holding device 9, which is shown in more detail in FIG. 4, in such a way that the pivotable portion 8 of the front hood 3 can be pivoted about a front pivot axis 12 from the usage position 7 of the pivotable portion of the front hood into a table position 13 in which the inside 6 has been pivoted outward and in which, as can be seen, the pivotable portion 8 of the front hood 3 protrudes beyond a vehicle front 14 forward and not upward.

In the sense of the disclosure, "front pivot axis 12" refers to a virtual pivot axis which is arranged at the front. In an example embodiment, the front pivot axis 12 is substantially perpendicular to the plane spanned by the longitudinal axis of the vehicle and the vertical axis of the vehicle. Of course, the angle can also deviate somewhat from the mentioned perpendicular angle, such a deviation lying in the tolerance range. Of course, the front pivot axis 12 could also be stationary.

The front hood 3 and also the pivotable portion 8 thereof together take on the usual tasks of a normal front hood with respect to styling and aerodynamics. Therefore, the outside 4 of the front hood 3, and also the pivotable portion 8 of the front hood, is adapted to the mentioned requirements and thus has, for example, a slight curvature, which can be seen in FIGS. 1 to 3. In contrast, the inside 6, especially the inside 6 of the pivotable portion 8 of the front hood 3, is flat. In the usage position 7, the pivotable portion 8 and the rest of the front hood 3 are connected to one another such that a unit is formed which satisfies the aforementioned requirements. Only a separation gap 5 between the pivotable portion 8 of the front hood 3 and the rest of the front hood 3 can be seen, both elements being locked to one another when the front hood 3 is in the usage position 7 shown in FIG. 1. The locking of the two elements to one another is released in a known way when the pivotable portion 8 of the front hood 3 is to be pivoted into the table position 13. The unlocking of the pivotable portion 8 of the front hood 3 and the pivoting thereof into the table position 13 and back can be accomplished manually or by actuators, such as by an electric motor for example. The locking and the pivoting back into the usage position 7 can also be accomplished by suitable actuators, e.g., by an electric motor.

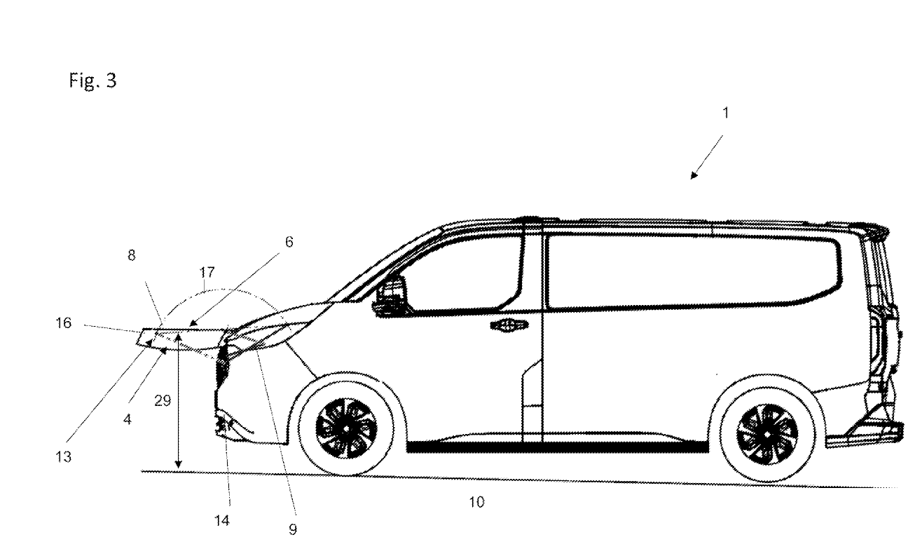

It is clear from FIG. 2, but most clear from FIG. 3, that the inside 6 is flat and, in the table position 13, is horizontal, i.e. is oriented parallel to a base surface 10, relative thereto, on which the vehicle 1 stands.

FIG. 3 shows the vehicle 1 from FIGS. 1 and 2 in a side view. In FIG. 3 it can be seen that the rear end 16 of the pivotable portion 8 of the front hood 3 is pivoted about the front pivot axis 12 toward the vehicle front 14 in such a way that the rear end follows a semicircular path 17, so that, in the table position 13 of the pivotable portion 8 of the front hood 3, the rear end 16 is spaced apart from the vehicle front 14, and in particular thus protrudes forward beyond the vehicle front 14. A front end 18 of the pivotable portion 8 of the front hood 3 opposite from the rear end 16 is moved at least in the vertical direction during the pivoting movement from the usage position 7 into the table position 13 and back. It is in accordance with the embodiment presented by way of example if the front end 18 is moved somewhat forward or (rather) backward and (depending on the hood height) raised or lowered. The front end 18, which, in the table position 13, is oriented toward the rear, can shift out of the vehicle, i.e. be moved upward in the drawing plane of FIG. 3, in the process.

The front pivot axis 12 extends in the transverse direction of the vehicle 1 and, as can be seen in FIGS. 1 and 2, is arranged below a top edge of a radiator grille 19. The radiator grille 19 has laterally arranged cutouts, which cannot be clearly seen in the figures but are hinted at, in order to give the pivoting and holding device 9 the necessary free space.

Merely by way of example, in FIG. 4 the pivoting and holding device 9 is shown as a detail and is in the form of a multi-link mechanism which has a hood strut 21, a structure strut 22 and two levers, specifically a front lever 23 and a rear lever 24. This embodiment is advantageous in that the pivoting and holding device 9 can be produced as a prefabricated subassembly and can also be retrofitted. In an example embodiment, a pivoting and holding device 9 is arranged on both sides of the pivotable portion 8 of the front hood 3, the pivoting and holding devices being identical. The pivoting and holding device 9 shown in FIG. 4 could of course also be implemented without a hood strut and/or a structure strut. Then only the front lever 23 and the rear lever 24 would have to be fastened, at the required attachment points, to the pivotable portion 8 of the front hood 3 and to the vehicle structure 11.

The hood strut 21 is fastened to the pivotable portion 8 of the front hood 3. By way of example, the hood strut 21 is arranged at an inclination with respect to the inside 6. An end 26 of the hood strut 21 which is at the rear in the table position 13 is arranged higher, relative to the base surface 10, than an opposite front end 27. Because the rear end 26 is arranged higher, the pivotable portion 8 of the front hood 3 can be moved forward during the transition from the usage position 7 into the table position 13, wherein the pivotable portion 8 of the front hood 3 is also raised and the levers 23, 24 fastened to the vehicle structure 11 are also forced to move on circular paths. Thus, the usable length of the pivotable portion 8 of the front hood 3 is increased. In contrast, in a vehicle having a very high front hood, the pivotable portion 8 of the front hood 3 could be moved downward in the table position 13, possibly below the vehicle front, for example by arrangement of the rear end 26 below the front end 27. By way of example, the hood strut 21 is rigidly fastened to a lateral surface 28 of the pivotable portion 8 of the front hood 3 such that the hood strut extends downward from the rear end 26 toward the front end 27 in the drawing plane of FIG. 4, with respect to the inside 6. If the pivotable portion 8 of the front hood 3 is in the usage position 7 like the front hood, the end 26 which is at the rear in the table position 13 is arranged at the front and the end 27 which is at the front in the table position 13 is arranged at the rear. The rear end 26 of the hood strut 21 which is arranged at the rear in the table position 13 therefore does not stay in its position during the pivoting movement from the table position 13 into the usage position 7 and back, but rather is moved at least in the vertical direction but also forward and back along a movement path, similarly to the movement of the front end 18.

The structure strut 22 is fastened to the vehicle structure 11 within the front compartment 2. The structure strut 22 likewise has an inclination, with a rear end 31 being arranged higher, relative to the base surface 10, than an opposite front end 32. The orientation and position of the structure strut 22 remain unchanged when the pivotable portion 8 is pivoted into the table position 13 and back into the usage position 7.

As can be seen, the front lever 23 and the rear lever 24 form four joints with the attachment points to the pivotable portion 8 of the front hood 3 and to the vehicle structure 11. The positioning of the four joints that is described above, i.e. the inclination of the structure strut 22 and of the hood strut 21, is merely presented by way of example. The positioning of the four joints relative to one another results from the specific vehicle geometry, i.e. especially the hood inclination and the height difference between the usage position 7 and the table position 13. It is in accordance with the disclosure if the rear end 26 and the front end 27 of the hood strut 21 are arranged at a common level, i.e. are not arranged one above the other or one below the other on the pivotable portion 8 of the front hood 3.

The front lever 23, as well as the rear lever 24, is connected, e.g., rotatably connected, to the structure strut 22 and to the hood strut 21. The front lever 23 extends from the end 32 of the structure strut 22 which is at the front in the table position 13 to the end 27 of the hood strut 21 which is at the front in the table position 13. Correspondingly, the rear lever 24 extends from the rear end 31 of the structure strut 22 toward the end 26 of the hood strut 21 which, in the table position 13, is at the rear. The front lever 23 has a longer extent than the rear lever 24. The shorter, rear lever 24 pivots up only by a small angular range (like in the case of a trunk lid, the movement could be supported by a gas spring), while the longer, front lever 23 sweeps a very large angle. In the process, the front end 18 travels up and down and also somewhat forward and back. This has the advantage that the pivoting and holding device 9 can be hidden far back in the vehicle.

As already mentioned, the levers 23, 24 are rotatably connected to the structure strut 22 and to the hood strut 21, so that the pivotable portion 8 of the front hood 3 can be pivoted about the front pivot axis 12 into the table position 13 and back. It could also be said that the front pivot axis 12 extends through the rotatable connection of the front lever 23 to the front end 32 of the structure strut 22.

In the table position 13 of the pivotable portion 8 of the front hood 3, the levers 23, 24 also have a supporting function, i.e. a holding function, which sufficiently supports the weight of the pivotable portion 8 and an applied load acting thereon, so that the pivotable portion 8 arranged in the table position 13 is supported so as to be positionally stable. In order to be able to bring about the pivoting movement, and also the supporting function of, in particular, the front lever 23, without hindrance, the lateral cutouts in the radiator grille 19 are provided. The supporting function could be facilitated further by a (gas) spring between the levers 23, 24 or toward the struts 21, 22 or by an electric drive, in which case stops could also be provided for the end positions.

The stops for the table position could be variable within limits in order to adjust the horizontal position of the tabletop.

As can be seen in FIGS. 2 and 4, the front lever 23 supports the end 16 of the pivotable portion 8 of the front hood 3 which, in the table position 13, is at the front, while the rear lever 24 supports the rear end 18.

In the table position 13, the flat inside 6 of the pivotable portion 8 of the front hood 3 can also be in the form of a table surface or a work surface. If the inside 6 is in the form of a table surface, it can have a completely flat covering and can be used, for example, as a breakfast table or the like. If the inside is in the form of a work surface, it can have a covering designed like perforated panels, i.e. like so-called peg boards, so that different grippers, clamping tools and/or work tools can be fastened thereto. The coverings are designed to be exchangeable, meaning that the appropriate covering can be attached according to the desire of the vehicle user and the particular situation.

In the table position 13, the inside 6 pivoted outward can have a height 29 (see FIG. 3) that may be 70 cm to 110 cm above the base surface on which the vehicle 1 stands.

In FIGS. 1 to 4, a curved design of the outside 4 and a flat design of the inside 6 can be seen. It is in accordance with the disclosure if another reinforcing element in the design as a rigid foam block is arranged on the inside 6 under the aforementioned covering, i.e. oriented toward the outside 4, when the front hood 3, i.e. also its pivotable portion 8, is in the usage position 7, on which reinforcement element the exchangeable covering (flat or e.g. in the form of a peg board) can then be arranged. The rigid foam block can be designed such that it can absorb applied input loads, i.e. can reduce them such that protection of external objects is also made possible in the case of unfavorable traffic events.

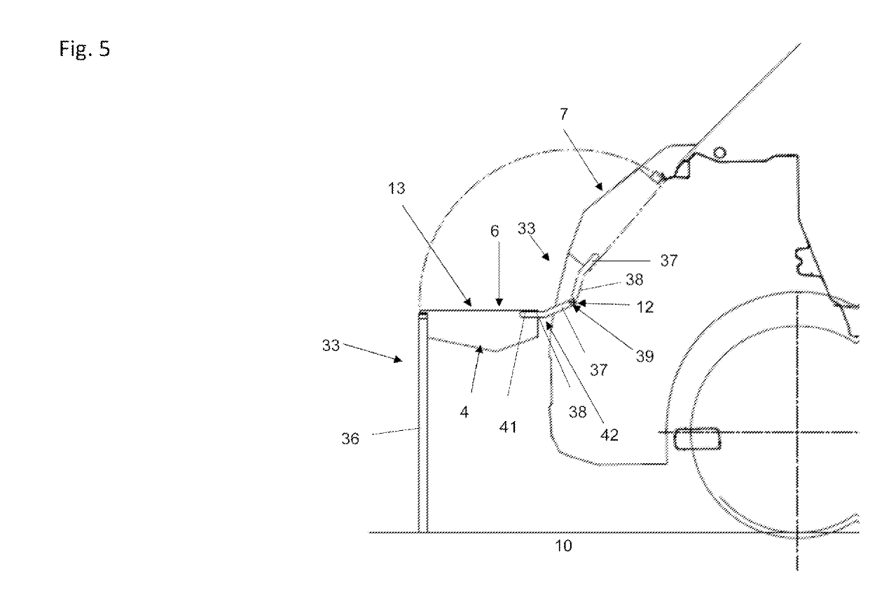

FIG. 5 shows a further exemplary embodiment of a pivoting and holding mechanism 33 which has a pivot lever 34 and a support element 36. The design of the pivotable portion 8 of the front hood 3 is identical to that described with respect to FIGS. 1 to 4, to which reference is made in full also in regard to the design of the pivoting and holding device 33 according to FIG. 5 in order to not have repetitions. This simple and robust variant of the pivoting and holding device 33 can be used in particular in the case of utility vehicles having a very short front overhang and a steep front hood 3. The pivot lever 34 has a structure arm 37 and a hood arm 38, the structure arm 37 and the hood arm 38 being arranged at angle to one another. Thus, as can be seen in FIG. 5, in the table position 13 the inside 6 of the pivotable portion 8 of the front hood 9 is arranged parallel to the base surface 10. In the usage position 7, the pivot lever 34 nestles against the vehicle structure 11 due to the angular design of the pivot lever. The pivot lever 34 may be provided on both sides of the pivotable portion 8 of the front hood 3 and is in particular rotatably fastened at one of its ends, specifically the free end 39 of the structure arm 36, to the vehicle structure 11 and forms the front pivot axis 12 there, which in this embodiment is stationary. At its opposite end, specifically the free end or, as shown, the free end region 41 of the hood arm 36, the pivot lever 34 is rigidly connected to the pivotable portion 8 of the front hood 3. Thus, the pivotable portion 8 of the front hood 3 can be pivoted from the usage position 7 into the table position 13 and back, which is indicated by the semicircular pivoting path 17. In the table position, the pivotable portion 8 of the front hood 3 can be supported by the support element 36. The support element 36 can be expediently arranged on the pivotable portion 8 of the front hood 3 for this purpose, and in particular can be telescopingly extendable. In an example embodiment, the support element 36 is arranged on the rear end 16 of the pivotable portion 8 of the front hood 3 and, as can be seen, can be extended toward the base surface 10 or alternatively at an inclination toward the vehicle structure 11, so that, in the table position 13, sufficient support is provided, with additional support by the pivot lever 34. Alternatively or additionally, it is possible to design a support element as an appropriately resistant hinge which is arranged on the front end 18 of the pivotable portion 8 of the front hood 3.

There is also a gap 42 between the front end 18 and the vehicle front, which can best be seen in FIG. 5.

With reference to FIGS. 1 to 5, it was explained that a pivotable portion 8 of the front hood 3 can be pivoted about the front pivot axis 12 into the table position 13 and back. Of course, it is in accordance with the disclosure if the entire front hood 3 is pivoted about the front pivot axis 12 into the table position 13 shown in FIGS. 2 to 4 and back. For this purpose, the described pivoting and holding device 9, 33 is connected to the front hood 3 and to the vehicle structure 11.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure. The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

### LIST OF REFERENCE SIGNS:

1 Vehicle

2 Front compartment

3 Front hood

4 Outside

5 Separation gap

6 Inside

7 Usage position

8 Pivotable portion of 3

9 Pivoting and holding device

10 Base surface

11 Vehicle structure

12 Pivot axis

13 Table position

14 Vehicle front

16 Rear end of 8

17 Semicircular path

18 Front end of 18

19 Radiator grille

21 Hood strut

22 Structure strut

23 Front lever

24 Rear lever

26 Rear end of 21

27 Front end of 21

28 Lateral surface of 8

29 Height

31 Rear end of 22

32 Front end of 22

33 Pivoting and holding device

34 Pivot lever

36 Support element

37 Structure arm

38 Hood arm

39 Free end of 36

41 Free end region of 37

42 Gap

1. An assembly comprising:
a first hood portion supportable by a vehicle structure;
a second hood portion pivotable relative to the first hood portion about a pivot axis between a closed position and a usage position, the second hood portion having an outside surface and an inside surface opposite the outside surface; and
a pivoting and holding device that attaches the second hood portion to the vehicle structure such that the second hood portion is pivoted about the pivot axis from the closed position into the usage position that comprises a table position in which the inside surface has been pivoted outward and protrudes beyond the first hood portion.

2. The assembly as recited in claim 1, wherein the pivoting and holding device is arranged within a compartment underneath the second hood portion when in the closed position.

3. The assembly as recited in claim 1, wherein the pivoting and holding device comprises a multi-link mechanism.

4. The assembly as recited in claim 3, wherein the multi-link mechanism comprises at least a hood strut that is attached to the second hood portion and a structure strut that is attached to the vehicle structure.

5. The assembly as recited in claim 4, wherein the hood strut has a hood strut front end and a hood strut rear end, and wherein the structure strut has a structure strut front end and a structure strut rear end, and wherein the multi-link mechanism comprises a front lever and a rear lever, and when in the table position:
the front lever has front lever forward end coupled to the hood strut front end and a front lever rearward end coupled to the structure strut front end; and
the rear lever has a rear lever forward end coupled to the hood strut rear end and a rear lever rearward end coupled to the structure strut rear end.

6. The assembly as recited in claim 5, wherein the hood strut rear end is higher relative to ground level than the hood strut front end when in the table position.

7. The assembly as recited in claim 5, wherein the structure strut has an inclination, with the structure strut rear end being arranged higher relative to ground level than the structure strut front end when in the table position.

8. The assembly as recited in claim 1, wherein the pivoting and holding device comprises a pivot lever and a support element.

9. The assembly as recited in claim 8, wherein the support element comprises an arm that extends downward toward ground when in the table position.

10. The assembly as recited in claim 1, wherein the inside surface of the second hood portion is arranged parallel to ground level when in the table position.

11. The assembly as recited in claim 1, wherein the inside surface of the second hood portion is flat.

12. A vehicle comprising:
a front compartment;
a front hood supportable by a vehicle structure, wherein the front hood closes the front compartment;
a hood portion pivotable relative to the front hood about a pivot axis between a closed position and a usage position, the hood portion having an outside surface and an inside surface opposite the outside surface; and
a pivoting and holding device that attaches the hood portion to the vehicle structure such that the hood portion is pivoted about the pivot axis from the closed position into the usage position that comprises a table position in which the inside surface has been pivoted outward and protrudes beyond the front hood.

13. The vehicle as recited in claim 12, wherein:
the inside surface faces the front compartment and the outside surface faces outer surroundings of the vehicle when in the closed position; and
the outside surface faces ground level and the inside surface faces the outer surroundings when in the table position.

14. The vehicle as recited in claim 13, wherein the inside surface of the hood portion is arranged parallel to ground level when in the table position.

15. The vehicle as recited in claim 13, wherein the inside surface of the hood portion is flat.

16. The vehicle as recited in claim 12, wherein the pivoting and holding device is arranged within the front compartment when in the closed position.

17. The vehicle as recited in claim 12, wherein the pivoting and holding device comprises a multi-link mechanism that includes at least a hood strut that is attached to the hood portion, a structure strut that is attached to the vehicle structure, a front lever connecting ends of the hood strut and the structure strut to each other, and a rear lever connecting opposite ends of the hood strut and the structure strut to each other.

18. The vehicle as recited in claim 12, wherein the pivoting and holding device comprises a pivot lever and a support element.

19. A method comprising:
supporting a first hood portion on a vehicle structure;
attaching a second hood portion to the first hood portion for pivoting movement about a pivot axis between a closed position and a usage position, the second hood portion having an outside surface and an inside surface opposite the outside surface; and
attaching the second hood portion to the vehicle structure with a pivoting and holding device such that the second hood portion is pivoted about the pivot axis from the closed position into the usage position that comprises a table position in which the inside surface has been pivoted outward and protrudes beyond the first hood portion.

20. The method as recited in claim 19, wherein the inside surface is flat, and including using a multi-link mechanism associated with the second hood portion and the vehicle structure to orientate the inside surface to be parallel to ground level when in the table position.
